(19) United States
(12) Patent Application Publication
(10) Pub. No.: US 2021/0278372 A1
(43) Pub. Date: Sep. 9, 2021

(54) DEVICE AND METHOD FOR THE NONDESTRUCTIVE TESTING OF A COMPONENT

(71) Applicant: SIEMENS AKTIENGESELLSCHAFT, MÜNCHEN (DE)

(72) Inventors: Michael Clossen-von Lanken Schulz, Issum (DE); Paul Dreischer, Bochum (DE); Stefan Obermayr, Duisburg (DE)

(21) Appl. No.: 16/610,099

(22) PCT Filed: Apr. 20, 2018
(86) PCT No.: PCT/EP2018/060137

§ 371 Date: Nov. 1, 2019

(30) Foreign Application Priority Data
May 31, 2017 (DE) 10 2017 209 151.7

(51) Int. Cl. G01N 27/9013; G01B 21/00

(52) U.S. Cl. CPC G01N 27/9013; G01B 21/00

(57) ABSTRACT

Provided is a device for nondestructive testing of a component, including a main body, test probes held on the main body, at least two displacement-indicator apparatuses held on the main body, each displacement-indicator having a displacement-sensing element, which is movably held on the main body, each displacement-indicator being designed to output a movement signal in response to the displacement-sensing element thereof being moved relative to the main body, which movement signal contains information about the instantaneous velocity of the movement of the displacement-sensing element relative to the main body or from which movement signal can be derived, and a displacement-indicator evaluation unit connected to the displacement-indicator apparatuses and designed and configured to receive movement signals from the displacement-indicator apparatuses during operation and to determine which displacement-indicator apparatus has the displacement-sensing element moving the fastest to output the movement signal of the displacement-indicator apparatus having the displacement-sensing element moving the fastest.

### CROSS-REFERENCE TO RELATED APPLICATIONS

This application claims priority to PCT Application No. PCT/EP2018/060137, having a filing date of Apr. 20, 2018, which is based on German Application No. 10 2017 209 151.7, having a filing date of May 31, 2017, the entire contents both of which are hereby incorporated by reference.

### FIELD OF TECHNOLOGY

The following relates to a device and a method for the non-destructive testing of a component.

### BACKGROUND

A number of different measurement methods are available for non-destructive testing of components. These include, for example, eddy-current-based, ultrasonic, magnetic field-based, and optical measurement techniques. In these techniques a main body, on which one or more test probes designed in accordance with the particular procedure are held, is usually moved on the surface of a component to be tested in order to obtain information about the composition of the surface and/or the interior volume of the component over the entire area which is covered as a result of the procedure. The test probe(s) held on the main body generate scanning signals and acquire measurement signals, from which, for example, statements can then be made as to the presence of cracks or other faults in a non-destructively tested component.

To enable a positional assignment between the signals acquired during the procedure with the one or more test probe(s) and the location points on the component surface, at which the test probe(s) was or were positioned to acquire the measurement signals in each case, additional location information of the main body relative to the surface is needed. This information is typically obtained using a displacement-indicator device held on the base body with a rotationally supported roller which acts as a displacement-sensing element. If in order to test a component the base body, which is fitted with one or more test probe(s), is moved along a component by hand or by motorized means, the roller is set in motion and as a result, the displacement-indicator device outputs a movement signal, for example in the form of a TTL signal, from which the location information can be derived in a sufficiently well-known manner. In general, the movement signal of the displacement-indicator device is forwarded to a test probe evaluation unit, in the case of an eddy-current test, for example, to an eddy-current device, and on the basis of the movement signal and the measurement data of the test probes a spatially resolved data record can be created.

In particular in the particular case that a multiplicity of test probes is provided on the main body, with which measurements are made simultaneously in operation, the problem can occur that associated location information cannot be obtained for the entire set of measurement data acquired with the test probes. This is the case, for example, if due to the arrangement of the roller and the extent of an array formed by the test probes, in particular in the direction of movement of the main body, it may occur that measurement signals for the component are already acquired with the test probes before the roller comes into contact with the component surface, and/or measurement data are still acquired after contact between the roller and the component has already ended. As a result, measurement signals relating to the component composition without location information are available and it is possible, for example, that the presence of a crack can be deduced but without knowing where the crack is. The data are then are barely usable, if at all.

On the basis of this known art, an object of embodiments of the present invention is therefore to specify a device and a method for non-destructive testing, with which over the entire investigated region of components to be tested, spatially resolved information about the composition of the component can be reliably obtained.

### SUMMARY

An aspect relates to a device for the non-destructive testing of a component, comprising
a main body, which for the non-destructive testing of a component to be inspected is designed to be moved along the component,
a plurality of test probes held on the main body for the non-destructive testing of the component, which are designed to generate scanning signals and to acquire measurement signals,
at least two displacement-indicator devices held on the main body for determining position coordinates associated with acquired measurement signals, each displacement-indicator device having a displacement-sensing element, which is movably, in particular rotationally, supported on the main body and being arranged such that it can be brought into contact with the surface of a component to be inspected, each displacement-indicator device being designed to output a movement signal in response to the displacement-sensing element thereof being moved relative to the main body, which movement signal contains information about the instantaneous velocity of the movement of the displacement-sensing element relative to the main body or from which movement signal such a velocity can be derived, and
a displacement-indicator evaluation unit, which is connected to the displacement-indicator devices and is designed and configured to receive movement signals from the displacement-indicator devices during operation and to determine either continuously or at specified time intervals which displacement-indicator device has the fastest moving displacement-sensing element, and in particular to output the movement signal of the displacement-indicator device having the fastest moving displacement-sensing element.

In addition, the aspect is achieved by a method for the non-destructive testing of a component, in which
a component to be inspected is provided,
a device for the non-destructive testing of a component, in particular according to embodiments of the present invention, is provided, which comprises a main body and a plurality of test probes held thereon, which are designed to generate scanning signals and to acquire measurement signals, and at least two displacement-indicator devices held on the main body for determining position coordinates associated with acquired measurement signals, each displacement-indicator device having a displacement-sensing element, which is movably, in particular rotationally, supported on the main body and being arranged such that it can be brought into contact with the surface of a component to be inspected, each displacement-indicator device being designed to output a movement signal in response to the displacement-sensing element thereof being moved relative to the main body, which movement signal contains information about the velocity of the movement of the displacement-sensing element relative to the main body or from which movement signal such a velocity can be derived,
the main body is displaced along the component in such a way that the displacement-sensing elements come into contact with a surface of the component and as a result of the displacement are set into motion, in particular into rotation, and during the displacement scanning signals are generated by means of the test probes and measurement signals are acquired, and movement signals are output by the displacement-indicator devices, and
continuously or at predefined time intervals the movement signals of the displacement-indicator devices are compared with each other and on the basis of the comparison it is determined which displacement-indicator device has the fastest moving displacement-sensing element, and in particular the movement signal of the displacement-indicator device with the fastest moving displacement-sensing element is output for assignment to measurement signals acquired with the test probes.

The basic idea of embodiments of the present invention, in other words, consists of providing the main body carrying the test probes of more than one, exactly two displacement-indicator devices with, in particular, one displacement-sensing element each, and during operation monitoring which of the displacement-sensing elements is currently moving the fastest.

Using at least two displacement-sensing elements, on the one hand it is possible, even in the presence of a plurality of test probes held on the main body, to obtain location information relating to the entire area of a component under test covered by the probes. For example,—in relation to a specified displacement path—a displacement-sensing element can be arranged on both sides of a test probe array so that a displacement-sensing element already comes into contact with the component in a region to be tested before the test probe that arrives first in the displacement direction reaches this region, and the other displacement-sensing body remains in contact until the last arriving test probe in the displacement direction has “scanned” the region.

On the other hand, the use of more than one displacement-indicator device increases the reliability of the location information. The embodiments rely here on the recognition that a displacement-sensing body which does not correctly image the actual displacement path generally moves more slowly than one for which this does not apply, for example, because the displacement-sensing body is momentarily not in engagement with the component and/or is subject to slip, possibly caused to contamination with dirt. By means of the approach according to embodiments of the invention, according to which during operation it is continuously or repeatedly checked which of the plurality of displacement-sensing elements is currently moving the fastest and, in particular, only this one is taken into account, according to embodiments of the invention it is ensured that the signal from the “correct” displacement-indicator device is always used for the location information. In particular, the movement signal of the displacement-indicator device which originates from the currently fastest moving displacement-sensing element is always exclusively used and taken into account for the assignment to the measurement data acquired with the test probes.

Immediately after the initial startup in an initial state, the movement signal of one (arbitrary) displacement-sensing device is first deemed the fastest and therefore the “correct” one for a test procedure, and this signal is output and taken into account first for the assignment to measurement signals acquired with the test probes. If the examination of the current speeds, carried out continuously or repeatedly at specified intervals of all, or in the case of two, both displacement-sensing elements, reveals that another or the other displacement-sensing element is moving faster, in particular with a higher rotation speed, then the device is “switched over” to the displacement-indicator device with the fastest, or in the case of two displacement-indicator devices the faster, displacement-sensing element and the movement signal thereof is output accordingly. It is clear that a displacement-sensing element which is currently not being moved at all, for example because it is not or no longer in contact with the component to be tested, has a speed of zero. If, for example, exactly two displacement-sensing elements are present and only one of these is currently moving, the moving displacement-sensing element is therefore currently the fastest.

According to a preferred embodiment of the device according to embodiments of the invention, the displacement-indicator devices are designed to output TTL signals as movement signals. Each displacement-indicator device is designed, in particular, to output two TTL signals phase-shifted by 90° relative to each other, which is also referred to as a 2-phase TTL signal. In this case, in a known manner the direction of rotationally supported displacement-sensing elements contained can be read off the associated movement signal.

The displacement-indicator evaluation unit is designed and configured to count the phase changes of the TTL signals output by the displacement-indicator devices and/or, through comparison of the TTL signals of the displacement-indicator devices, to determine when the phase of a TTL signal of one displacement-indicator device matches the phase of a TTL signal of another displacement-indicator device. Accordingly, the method according to embodiments of the invention is characterized in that the phase changes of the TTL signals output by the displacement-indicator devices are counted and/or through comparison of the TTL signals it is determined when the phase of a TTL signal of one displacement-indicator device matches the phase of a TTL signal of another displacement-indicator device. The phase changes in the TTL signals are to be understood, in particular, to mean the rising and falling edges in these. The counting and phase comparison are particularly carried out in combination in this order.

In addition, exactly two displacement-indicator devices are provided, each with one displacement-sensing element, or in the context of the method according to embodiments of the invention a device for the non-destructive testing of a component with exactly two displacement-indicator devices, each with one displacement-sensing element, is provided. In this case, the displacement-indicator evaluation unit can then be configured in such a way that it changes from the output of a TTL signal of the one displacement-indicator device to an output of the TTL signal of the other displacement-indicator device if the count of the phase changes has shown that in the TTL-signal of the other displacement-indicator device a larger number of phase changes occurs within a time interval than in the TTL signal of the one displacement-indicator device in the time interval and, in addition, if the phase of the TTL signal of the one displacement-indicator device matches the phase of the TTL signal of the other displacement-indicator device. In the method according to embodiments of the invention, in an analogous way it can be provided that a change is made from the output of TTL signals of the one displacement-indicator device to an output of the TTL signals of the other displacement-indicator device if these conditions are met. If each displacement-indicator device outputs two TTL signals offset by 90° degrees in response to a movement of its displacement-sensing element, thus in the case of two displacement-indicator devices a total of four TTL signals are output, it is sufficient if phase equality only exists between one of the two TTL signals of the one displacement-indicator device and one of the two TTL signals of the other displacement-indicator device. As of the instant at which the first condition is met, thus when a greater number of phase changes exists in the TTL signal of the other displacement-indicator device, the device waits until the second condition is met, i.e. the phase correspondence occurs, and then the change takes place when the phase equality occurs.

According to a further embodiment the device comprises a test probe evaluation unit, which is separate in particular with respect to the main body, and which is connected via cables to the test probes held on the main body and to the displacement-indicator evaluation unit. The displacement-indicator evaluation unit is configured in particular in such a way that it always only outputs movement signals of the displacement-indicator device with the currently fastest moving displacement-sensing element to the test probe evaluation unit for assignment to measurement signals acquired with the test probes. In the method according to embodiments of the invention it can be provided that the displacement-indicator evaluation unit always forwards only the movement signal of the displacement-indicator device with the fastest moving displacement-sensing element to the test probe evaluation unit for assignment to acquired measurement signals.

If the test probes are eddy-current probes, the test probe evaluation unit is formed, for example, by an eddy-current device to which the measurement signals acquired with all the eddy-current probes are transferred. Then, according to embodiments of the invention—in addition to the test head measurement data—only the movement signal which is due to the currently fastest moving displacement-sensing element is always transferred to the eddy-current device in order to be taken into account for a location-dependent representation and processing of the measurement data. Commercially available eddy-current devices are designed to acquire the movement signal from only one displacement-indicator device. The approach according to the method according to embodiments of the invention thus enables the continued use of the conventional eddy-current devices while eliminating the disadvantages inherent in the use of only one displacement-indicator device.

In a particularly preferred design the displacement-indicator evaluation unit comprises or is formed by at least one, in particular programmable, microcontroller. If at least one microcontroller is provided, this comprises a circuit board and/or a microprocessor and/or a multiplicity of input/output connections. Particularly the microcontroller is designed as or comprises an Arduino board. Programmable microcontrollers sold under the brand name Arduino are already known from the known art. These comprise, in particular, a printed circuit board with a microprocessor and input/output pins. They can be connected to a voltage source, for example via a USB port, and then if necessary, supply electrical energy to further components in turn. If the microcontroller is provided by an Arduino board, or comprises such a board, the displacement-indicator devices are connected, in particular via suitable cables, to so-called interrupt pins of this board and the movement signals are transferred, in particular, via the interrupt pins. With the interrupt pins it is possible to react to events that occur in the movement signals, which are in the form of TTL signals. In the particular case in which two displacement-indicator devices are provided, each of which outputs two TTL signals offset by 90 degrees, a total of four displacement-indicator device outputs are connected to the microcontroller, which is provided in particular by an Arduino board.

Particularly, the displacement-indicator evaluation unit is designed and configured for carrying out the method according to embodiments of the invention. In particular, one or more programs can be stored on this unit, by means of which the necessary computing and/or control steps are implemented.

With regard to the arrangement of the displacement-sensing elements on the main body—in relation to the test probes held thereon—this should be particularly advantageously implemented in such a way that location information are obtained, in other words movement signals relating to the measurement data are output, even before the first test probe in the displacement direction reaches a component surface to be tested and at least until the complete departure of the last test probe in the displacement direction. It can be provided that the displacement-sensing elements are arranged on opposite end regions of the main body. Also, the displacement-sensing elements can be arranged on two sides—in particular in relation to a displacement direction defined for the main body, for example on account of its shape—of at least one test probe array formed by a plurality of test probes, in particular all test probes. One displacement-sensing element is arranged in front of, in the displacement direction defined for the main body, at least one array formed by a plurality of, in particular all test probes, and one displacement-sensing element is arranged behind the same. An array is understood to mean a contiguous arrangement of a plurality of test probes, which in particular provides an uninterrupted scanning. For eddy-current test probes, in order to provide uninterrupted coverage it is known, for example, to arrange these on a main body in arrays with multiple diagonal rows.

The displacement-sensing elements can be designed in a known manner as rollers, each of which is mounted on the main body such that it can be rotated about a rotational axis. The arrangement is then, in particular, such that the axes of rotation of the rollers are oriented parallel to each other. To provide a good contact, rubber 0-rings can be fitted on the rollers. Alternatively or in addition to this, rollers can be used which are either manufactured from or comprise a magnetic material, in order to ensure a secure contact and to prevent slippage.

The main body can be characterized by a fir-tree or swallow-tail or T-shaped profile. This is true in particular if the device according to embodiments of the invention or the method according to embodiments of the invention for non-destructive testing of a component is used in the region of a groove of appropriate shape, for example, for a shaft coupler. The cross-sectional contour of the main body is then adapted to the cross-sectional contour of the groove. For testing, the main body is pushed into the groove from one side and pushed out from it again on the opposite side in a specified displacement direction. If a displacement-sensing element is arranged in the displacement direction in front of and behind at least one array of test probes held on the main body, movement signals become available before the first test probe reaches the groove surface and the other displacement-sensing element remains in contact with the inner surface of the groove when all the test probes are already located outside the groove.

In a particularly preferred embodiment, the main body is also designed to be hollow. The displacement-indicator evaluation unit and/or the test probes and/or the displacement-indicator devices can then be arranged in the hollow main body. With regard to the displacement-indicator devices it is appropriate, when the displacement-indicator elements are arranged in the main body, for at least some sections of the displacement-sensing elements to project from the base body in order to be brought into contact with the surface of a component to be tested.

The test probes are, for example, eddy-current test probes, which each comprise or are formed by at least one coil, and/or ultrasonic test probes and/or optical test probes, which each comprise at least one light source and at least one camera. If optical test probes for surface analysis are used, for example, the optical scanning is carried out in a similar way to that known for paper pages by a flatbed scanner.

### BRIEF DESCRIPTION

Some of the embodiments will be described in detail, with reference to the following figures, wherein like designations denote like members, wherein:

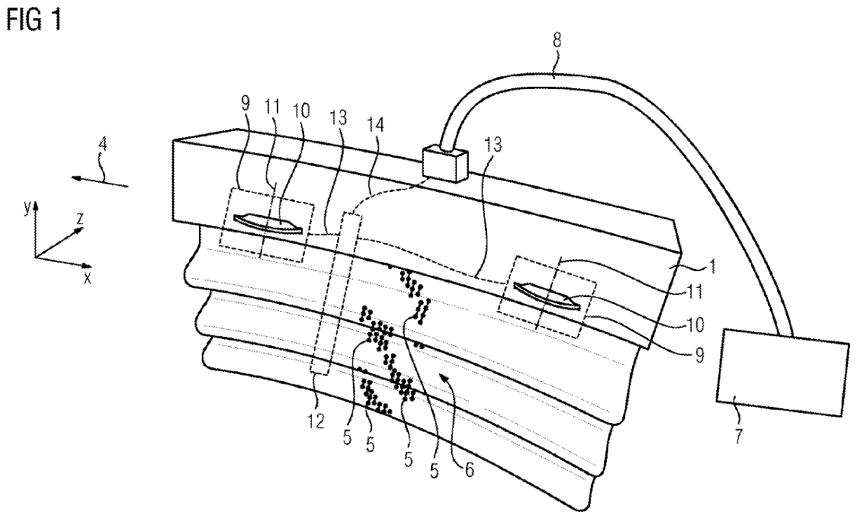

FIG. 1 depicts a schematic view of a device according to embodiments of the invention for the non-destructive testing of a component;

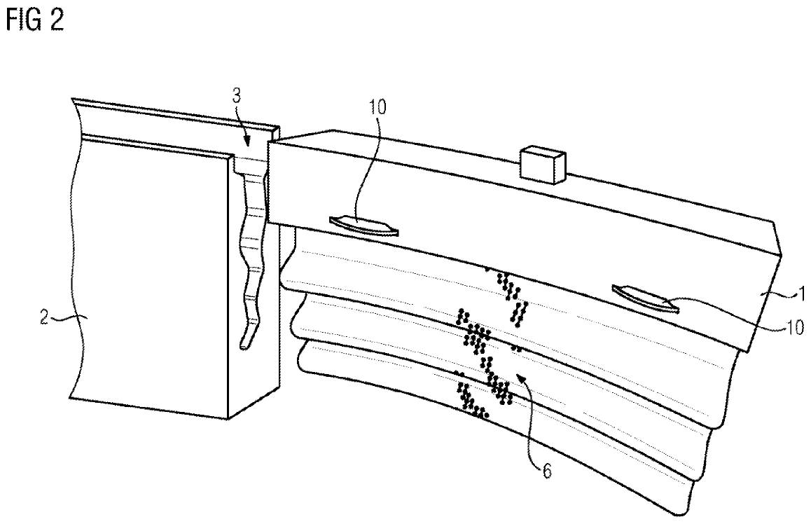

FIG. 2 depicts a main body of the device of FIG. 1 next to a shaft coupler to be inspected in a purely schematic representation;

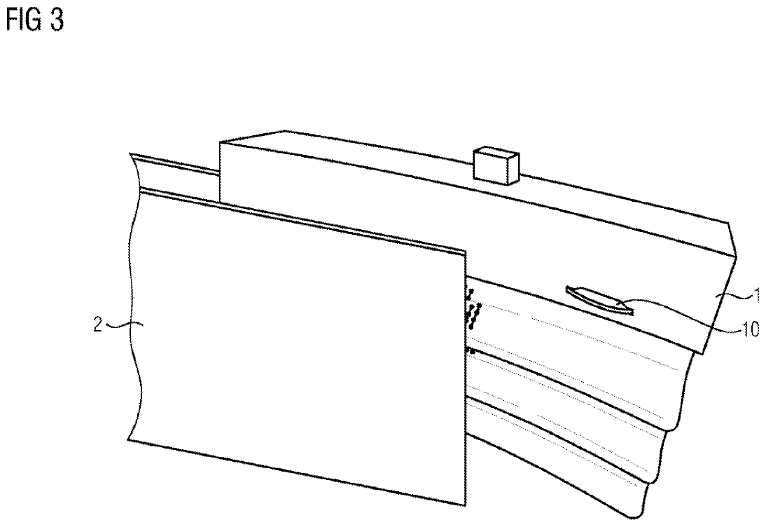

FIG. 3 depicts the main body of FIGS. 1 and 2 in a condition in which it is partially pushed into the shaft coupler in a purely schematic representation; and

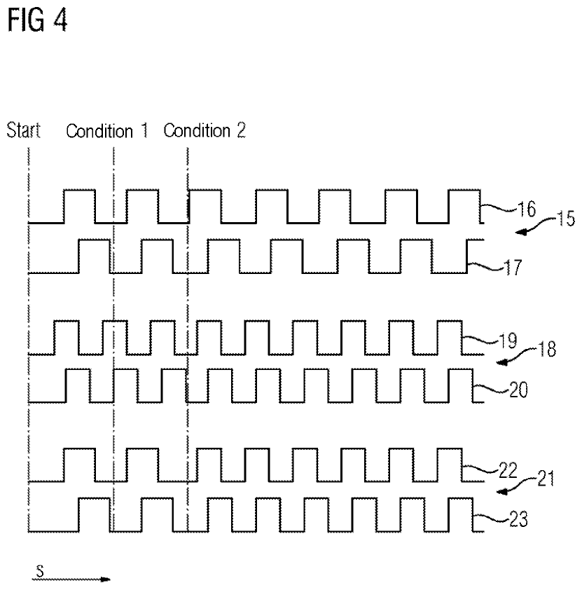

FIG. 4 depicts a diagram with the TTL signals of the displacement-indicator devices of the device from FIG. 1 and the TTL signal output by the displacement-indicator evaluation unit of the device.

### DETAILED DESCRIPTION

FIG. 1 shows an embodiment of a device according to embodiments of the invention for the non-destructive testing of a component in a purely schematic representation.

This comprises a hollow main body 1 made of plastic, which for non-destructively testing of a shaft coupler 2 to be inspected in accordance with the present example, only sections of which are shown in FIGS. 2 and 3, is to be displaced along the shaft coupler, specifically along a fir-tree shaped groove 3 provided therein for attaching a turbine blade not shown in the figures. The outer contour of the main body 1 is matched to the internal contour of the groove 3. In concrete terms, both the main body 1 and the groove 3 have a fir-tree-shaped profile of the same dimensions, so that the main body 1 can be inserted into the groove 3 in a form-fitting manner (cf. also FIGS. 2 and 3). The shape of the main body 1 and groove 3 results in a defined displacement direction, which is indicated in FIG. 1 by an arrow 4 and coincides with the trajectory of the curved groove 3.

On the main body 1 a plurality of eddy-current test probes 5 provided by coils is held, which are designed to generate scanning signals and to acquire measurement signals. In the present case these are arranged in a plurality of diagonal rows and form a test probe array 6, which as is apparent from the figure, extends over almost the entire extent of the main body 1 in the y-direction and only a part of its extent in the x-direction. The test probes 5 in the exemplary embodiment shown are arranged in the main body 1. Specifically, each test probe 5 is held in a through hole provided at an appropriate place in the main body wall. On the rear-facing side of the main body 1 in FIG. 1, another test probe array 6, not visible in the figure, is provided which comprises the same number of test probes 5, which are distributed in the same way. Since two test probe arrays 5 are provided, the shaft coupler 2 can be inspected in the region of the entire groove 3 in a test operation.

The device also comprises a test probe evaluation unit separate from the main body 1 in the form of a conventional eddy-current device 7. Each of the eddy-current probes 5 held on the main body 1 is connected to the eddy-current device 7 in the conventional way via a wire, not shown in the figure. The wires are bundled outside the main body 1 in the cable 8 visible in the figure, which feeds into the eddy-current test device 7. In FIGS. 2 and 3, for the purpose of simplifying the drawing the eddy-current device 7 and the cable 8 are not shown.

To enable a locational assignment between the measurement signals acquired with the eddy-current probes 5 and the location points on the groove surface, at which the test probe(s) 5 was or were positioned, to acquire the measurement signals additional location information of the main body 1 relative to the groove surface is needed. To obtain this the device comprises two displacement-indicator devices 9 for determining location coordinates associated with measurement signals, which in the example shown are arranged in the hollow main body 1. These are therefore shown with a dashed line in FIG. 1. In FIGS. 2 and 3 the displacement-indicator devices are not shown. Each of the two displacement-indicator devices 9 comprises a displacement-sensing element, provided in the present case by a roller 10. Each roller 10 is rotationally mounted on the base body 1 about a rotation axis 11, wherein the arrangement is of such a form that the rotation axes 11 of the two rollers 10 are oriented parallel to each other. As is apparent in the figures, the rollers 10 are arranged in such a way that sections thereof project from the base body 1, to be able to come into contact with the surface of the shaft coupler 2.

Of the rollers 10, as is apparent in FIG. 1, one is arranged on each side of the test probe array 6, specifically one—in relation to the defined displacement direction of the main body 1—in front of it, i.e. in FIG. 1 on the left, and one behind it in relation to the displacement direction, i.e. in FIG. 1 on the right of the array 6. With regard to the same position and structure of the test probe array 6 on the reverse of the main body 1 the same applies analogously.

Each of the two displacement-indicator devices 9 is designed, in response to the roller 10 thereof being rotated, to output a movement signal which contains information about the current speed of movement of the roller 10, or from which such a speed can be derived. In concrete terms, each of the displacement-indicator devices 9 is designed to output two TTL signals phase-shifted by 90° relative to each other, which is also referred to as a 2-phase TTL signal. To this end the displacement-indicator devices 9 comprise, in addition to the rollers 10, further mechanical and electronic components which are sufficiently well known from the known art and are not shown in the purely schematic FIG. 1.

Finally, the device according to embodiments of the invention comprises a displacement-indicator evaluation unit in the form of an Arduino board 12, which is arranged in the hollow base body 1 in exactly the same away as the displacement-indicator devices 9 and thus also shown with a dashed line. This is a microcontroller, which comprises a printed circuit board, a microprocessor and a plurality of input/output pins, including so-called interrupt pins, which are not visible in FIG. 1, as this only shows the Arduino board 12 in a purely schematic form.

Both displacement-indicator devices 9 are connected via suitable wires 13 to the interrupt pins of the board 12 and the transfer of the movement signals is carried out, in particular, via the interrupt pins. Using the interrupt pins, it is possible to react to events that occur in the movement signals.

The Arduino board 12 is also connected via a wire 14, which runs outside of the main body 1—together with the wires for the test probes 5—through the cable 8, to the eddy-current test device 7.

During a test procedure the displacement-indicator devices 9 transfer both their movement signals to the Arduino board 12 and the latter is designed and configured to identify at pre-defined intervals which displacement-indicator device 9 currently has the roller 10 that is moving fastest, and only the movement signal of the displacement-indicator device 9 with the currently fastest moving roller 10 is always output to the eddy-current device 7 for assignment to measurement signals acquired with the eddy-current probes 5.

In particular, the determination of which roller 10 is currently moving faster is carried out by means of a counter. If the roller 10 of the one displacement-indicator device 9 is faster, the value in a global variable is incremented. If the roller 10 of the other is faster, the same variable is decremented. Depending on whether the value is greater than 2 or less than −2, the respective faster moving displacement-indicator device 9 is selected. In order that the counter value does not run without limit, the counting interval in this case is limited to the numbers between −2 and 2. If a higher or lower waiting time is required in operation, this can be implemented flexibly by adjusting the counting interval.

In order to avoid step losses during the switchover process, the counting of the counter is subject to the additional condition that the two movement signals are the same. To this end, the two signals are directly compared. Only in the case of equality of all phases is the displacement-indicator device 9 with the faster roller 10 selected, which means the device switches over to output the movement signal of this roller to the eddy-current device 6. This is intended to avoid, e.g., an unwanted signal direction change, because the switching sequence in 2-phase TTL signals indicates the direction of rotation.

The above will become particularly clear from consideration of FIG. 4. This drawing shows a 2-phase TTL signal 15 with a first phase 16 and a second phase 17, shifted by 90° with respect to the latter, of the displacement-indicator device 9 on the left of FIG. 1 and a 2-phase TTL signal 18 with a first phase 19 and a second phase 20 shifted by 90 degrees with respect to this of the displacement-indicator device 9 on the right in FIG. 1, over the distance s. The roller 10 of the displacement-indicator device 9 on the left in FIG. 1, whose 2-phase TTL signal 15 is forwarded by the Arduino board 12 to the eddy-current device 5 as of the start of a measurement, is currently moving a little slower than that on the right, which can be seen from the larger distance between adjacent rising and falling edges in the signal 15.

At the onset of the first condition (see the related labeling in FIG. 4) the right-hand displacement-indicator device 9 has output two more edge changes than the left-hand one. From here on the phase equality is maintained. Only when the position labeled with “Condition 2” in FIG. 4 is reached does the phase equality exist. At this point the switchover occurs to the output of the 2-phase TTL signal 18 of the right-hand displacement-indicator device 9 instead of the left-hand one.

The resulting 2-phase TTL output signal 21 with a first phase 22 and a second phase 23, which from the start corresponds to the 2-phase TTL signal 15 of the left-hand displacement-indicator device 9 and from the switchover time corresponds to the 2-phase TTL signal 18 of the right-hand one, is also drawn in FIG. 4.

If the subsequent monitoring reveals at a later point in time that the roller 10 of the left-hand displacement-indicator device 9 is rotating faster than the right-hand one, the device switches back again, and so on.

For the purposes of implementing the foregoing a program with appropriate content is stored on the Arduino board 12.

To perform a non-destructive testing of the shaft coupler 2 in the area of the groove 3 for cracks, for example, the device shown in FIG. 1 is provided. The main body 1 is inserted from the right-hand side in FIGS. 1 to 3 into the groove 3, displaced in this groove and withdrawn from it again on the opposite side of the groove 3, not visible in the figures. In FIG. 3 the main body 1 is shown in the condition in which it is inserted roughly half-way into the groove 3.

As soon as the main body 1 is inserted so far into the groove 3 that the roller 10 of the left-hand displacement-indicator device in the figures comes into engagement with the component surface, the roller 10 is set into rotation by the displacement of the main body 1 in the groove 3, and as a result the associated displacement-indicator device 9 outputs a 2-phase TTL signal 15 corresponding to the speed as a movement signal to the Arduino board 12. Since at this point in time the roller 10 of the other displacement-indicator device 9 has not yet come into engagement with the shaft coupler 2 (cf. FIG. 3), this is not moved, hence it has a speed of zero, so that the 2-phase TTL signal 15 of the left-hand displacement-indicator device 9—as the faster of the two—is output from the Arduino board 12 to the eddy-current device 7. As soon as the eddy-current probes 5 reach the groove 3 (see also FIG. 3), these output measurement signals. Since the roller 10 of the left-hand displacement-indicator device is already in contact with the shaft coupler 2, associated location coordinates are available.

After a further insertion of the main body 1 into the groove 3 the second roller 10 also comes into engagement. If the first one moves—for example as a result of slip—slower than this latter, as described in more detail above, the device switches over to the signal 18 of the second displacement-indicator device 9 and this signal is forwarded to the eddy-current device 7. Even without slippage or the like, a change takes place in any case when the roller 10 of the left-hand displacement-indicator device 9 loses contact with the shaft coupler 2 and consequently no longer moves, because the main body 1 already projects by an appropriate distance out of the other side of the groove 3. But then the 2-phase TTL signal 18 of the right-hand displacement-indicator device 9 is still available and is forwarded by the Arduino board 12—as the then faster signal—to the eddy-current device 6. Since the right-hand displacement indicator is positioned behind the arrays 6 in the displacement direction, associated location information are available for all measurement data acquired with these.

As a result, all measurement data can be interpreted in a location-dependent manner. Uncertainties concerning the actual location of detected defects do not occur. In addition, inaccuracies as a result of slippage—at least over the region in which both rollers 10 are in contact in with the shaft coupler 2 in the region of the groove 3—are reliably avoided.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A device for a non-destructive testing of a component, the device comprising:
a main body, which for the non-destructive testing of the component to be inspected is designed to be moved along the component;
a plurality of test probes held on the main body for the non-destructive testing of the component, which are designed to generate scanning signals and to acquire measurement signals;
at least two displacement-indicator devices held on the main body for determining position coordinates associated with the acquired measurement signals, each displacement-indicator device having a displacement-sensing element, which is movably supported on the main body and being arranged such that the displacement-sensing element can be brought into contact with a surface of the component to be inspected, each displacement-indicator device being configured to output a movement signal in response to the displacement-sensing element thereof being moved relative to the main body, the movement signal containing information about an instantaneous velocity of a movement of the displacement-sensing element relative to the main body or from which the movement signal can be derived; and
a displacement-indicator evaluation unit, which is connected to the at least two displacement-indicator devices and is designed and configured to receive movement signals from the at least two displacement-indicator devices during operation and to determine, either continuously or at specified time intervals, which displacement-indicator device has a fastest moving displacement-sensing element, and to output the movement signal of the displacement-indicator device having the fastest moving displacement-sensing element for assignment to measurement signals acquired with test probers.

2. The apparatus as claimed in claim 1, wherein the at least two displacement-indicator devices are designed to output TTL signals as movement signals, and the displacement-indicator evaluation unit is designed and configured to count phase changes of the TTL signals output by the at least two displacement-indicator devices and/or through comparison of the TTL signals of the at least two displacement-indicator devices to determine when a phase of a TTL signal of one displacement-indicator device matches a phase of a TTL signal of another displacement-indicator device.

3. The device as claimed in claim 1, wherein exactly two displacement-indicator devices, each with one displacement-sensing element, are provided.

4. The device as claimed in claim 2, wherein the displacement-indicator evaluation unit is configured in such a way that the displacement-indicator evaluation unit changes from the output of a TTL signal of the one displacement-indicator device to an output of the TTL signal of the other displacement-indicator device if a count of the phase changes has shown that in the TTL-signal of the other displacement-indicator device a larger number of phase changes occurs within a time interval than in the TTL signal of the one displacement-indicator device in the time interval and in addition, if the phase of the TTL signal of the one displacement-indicator device matches the phase of the TTL signal the other displacement-indicator device.

5. The device as claimed in claim 1, further comprising: a test probe evaluation unit separate from the main body, which is connected via cables to the test probes held on the main body and to the displacement-indicator evaluation unit, and the displacement-indicator evaluation unit is configured in such a way that the displacement-indicator evaluation unut always only outputs movement signals of the displacement-indicator device with a currently fastest moving displacement-sensing element to the test probe evaluation unit for assignment to measurement signals acquired with the test probes.

6. The device as claimed in claim 1, wherein the displacement-indicator evaluation unit comprises at least one programmable microcontroller, wherein the at least one programmable microcontroller has a printed circuit board, a microprocessor and/or a multiplicity of input/output connections, wherein the microcontroller is designed in particular as an Arduino board.

7. The device as claimed in claim 1, wherein the displacement-sensing elements are arranged at opposite end regions of the main body and/or the displacement-sensing elements are arranged on two sides of at least one test probe array formed by a plurality of test probes.

8. The device as claimed in claim 1, wherein the displacement-sensing elements are implemented as rollers, wherein the rollers are supported on the main body such that the rollers can each rotate about a rotational axis, wherein the arrangement is such that rotational axes of the rollers are oriented parallel to each other and/or the rollers are manufactured from or comprise a magnetic material.

9. The device as claimed in claim 1, wherein the main body is a fir-tree- or swallow-tail- or T-shaped profile and/or that the main body is designed hollow and the displacement-indicator evaluation unit and/or the test probes and/or the displacement-indicator devices are arranged in the hollow main body, wherein if the displacement-indicator devices are arranged in the main body, the distance-sensing elements project from the main body in some sections in order to be able to be brought into contact with the surface of a component to be tested.

10. The device as claimed in claim 1, wherein the test probes are eddy-current test probes, which each comprise or are formed by at least one coil, and/or ultrasonic test probes and/or optical test probes, which comprise at least one light source and at least one camera.

11. The device as claimed in claim 1, wherein the displacement-indicator evaluation unit is designed and configured for carrying out the method.

12. A method for a non-destructive testing of a component, the method comprising:
providing a component to be inspected;
providing a device for the non-destructive testing of the component, which comprises a main body and a plurality of test probes held thereon, which are designed to generate scanning signals and to acquire measurement signals, and at least two displacement-indicator devices held on the main body for determining location coordinates associated with acquired measurement signals, each displacement-indicator device having a displacement-sensing element, which is movably, supported on the main body and being arranged such that the displacement-sensing element can be brought into contact with a surface of the component to be inspected, each displacement-indicator device being designed to output a movement signal in response to the displacement-sensing element thereof being moved relative to the main body, the movement signal containing information about an instantaneous velocity of a movement of the displacement-sensing element relative to the main body or from which the movement signal can be derived, wherein the main body is displaced along the component in such a way that the displacement-sensing elements come into contact with a surface of the component and as a result of the displacement are set into motion, and during the displacement of the main body by means of the test probes scanning signals are generated and measurement signals are acquired, and movement signals are output by the displacement-indicator devices; and
continuously or at predefined time intervals, comparing the movement signals of the displacement-indicator devices are compared with each other, and on a basis of the comparison it is determined which displacement-indicator device has a fastest moving displacement-sensing element, and the movement signal of the displacement-indicator device with the fastest moving displacement-sensing element is output for assignment to measurement signals acquired with the test probes.

13. The method as claimed in claim 12, wherein TTL signals are output by the displacement-indicator devices as movement signals, and phase changes of the TTL signals output by the displacement-indicator devices are counted and/or through comparison of the TTL signals it is determined when a phase of a TTL signal of one displacement-indicator device matches phase of a TTL signal of another displacement-indicator device.

14. The method as claimed in claim 12, wherein a device for the non-destructive testing of the component with exactly two displacement-indicator devices, each with a displacement-sensing element, is provided.

15. The method according to claim 13, wherein a change is made from the output of TTL signals of the one displacement-indicator device to an output of the TTL signals of the other displacement-indicator device if a count of the phase changes has shown that in the TTL-signal of the other displacement-indicator device more phase changes occur within a time interval than in the TTL signal of the one displacement-indicator device in the time interval and in addition, if the phase of a TTL signal of the one displacement-indicator device matches the phase of a TTL signal of the other displacement-indicator device.

16. The method as claimed in claim 12, wherein the device for the non-destructive testing of the component includes a test probe evaluation unit separate from the main body, which is connected via cables to the test probes held on the main body and to the displacement-indicator evaluation unit, and the displacement-indicator evaluation unit always only outputs the movement signal of the displacement-indicator device with the fastest moving displacement-sensing element to the test probe evaluation unit for assignment to acquired measurement signals.
